(19) United States
(12) Patent Application Publication
(10) Pub. No.: US 2017/0116621 A1
(43) Pub. Date: Apr. 27, 2017

(54) METHOD AND SYSTEM FOR PREDICTING SERVICE PROVIDER PERFORMANCE BASED ON INDUSTRY DATA

(71) Applicant: MasterCard International Incorporated, Purchase, NY (US)

(72) Inventors: Jean-Pierre GERARD, Croton-On-Hudson, NY (US); Kenneth UNSER, Fairfield, CT (US)

(73) Assignee: MasterCard International Incorporated, Purchase, NY (US)

(21) Appl. No.: 14/924,044

(22) Filed: Oct. 27, 2015

(51) Int. Cl. G06Q 30/02; G06F 17/30

(52) U.S. Cl. CPC G06Q 30/0202; G06F 17/30598; G06F 17/30424

(57) ABSTRACT

A method for analysis of metrics based on stored data sets includes: storing transaction data entries, each including data related to a transaction including an account identifier and a category code associated with a recipient of the transaction and transaction data; receiving a metric request, the request being related to a service provider including one or more requested metrics and business data, the business data including data related to one or more customers of the related service provider; identifying a specific category code or account identifiers using the business data; identifying transaction data entries where that includes one of the account identifiers or the specific category code; identifying one or more metrics based on the transaction data included the identified transaction data entries; and transmitting the identified one or more metrics in response to the metric request.

### FIELD

The present disclosure relates to a computer system specifically configured to predict performance of a service provider based on industry data, specifically the analysis of performance metrics for business-customers of a service provider based on their own customers for prediction of future performance for the service provider.

### BACKGROUND

For businesses that transact with individual consumers, performance can often be evaluated and predicted via analysis of the transactions conducted with the individual consumers. If the business wants to increase their commerce, they can often do so via targeting of individual consumers using advertisements, offers, rewards, loyalty programs, and other similar methods. This is often the case as businesses that transact with individual consumers often interact directly with their primary source of revenue, the consumers themselves.

However, service providers that serve these kinds of businesses will many times lack the ability to directly influence future performance. In many instances, these service providers are dependent on the needs of their business-customers. Thus, a service provider cannot increase revenue by providing advertisements and offers to their business-customers, as the business-customers themselves are at the mercy of their own individual consumers for revenue.

Because service providers do not participate in the transactions between their business-customers and the business's consumers, not only can the service providers not directly influence their revenue from the business-customer as a result, service providers are also unable to determine the performance of their business-customers. As a result, service providers must rely on information provided by their business-customers regarding their performance. However, such information may be inaccurate, outdated, or may even be deliberately false or misleading, such as if the business-customer is losing revenue and does not want to lose the services provided by the service provider as a result. In addition, such information may only be valuable as to the particular business-customer, and may be inaccurate as to performance of the other business-customers or the industry as a whole, necessitating the service provider to collect data from each of their customers, which, as discussed above, may not be accurate.

Thus, there is a need for a technical solution for the estimation and prediction of performance for a service provider that can capture performance of business-customers of the service provider accurately and efficiently using data for transactions involving the business-customers and their own consumers. By capturing this data directly for a service provider, and for each of the customers of the service provider, the level of accuracy and trust of the data may be significantly increased, and may also be reflective of industry performance as well as individual business performance, which may provide for even greater accuracy and benefit to service providers than data volunteered by their customers may provide.

### SUMMARY

The present disclosure provides a description of systems and methods for analysis of metrics based on stored data sets.

A method for analysis of metrics based on stored data sets includes: storing, in a transaction database of a specially programmed processing server, a plurality of transaction data entries, wherein each transaction data entry is a structured data set that includes data related to an electronic transaction including a plurality of data values storing data including at least an account identifier and a category code associated with a recipient of the electronic transaction and transaction data; receiving, by a receiving device of the processing server, an electronic data signal superimposed with data comprising a metric request, wherein the metric request is related to a service provider and includes a plurality of data values storing data including at least one or more requested metrics and business data, the business data including data related to one or more customers of the related service provider; identifying, by an identification module of the processing server, (i) a specific category code, or (ii) one or more account identifiers based on at least the business data included in the metric request; executing, by a querying module of the processing server, a query on the transaction database to identify a subset of transaction data entries where (i) the included account identifier corresponds to one of the one or more account identifiers, or (ii) the included category code corresponds to the specific category code; identifying, by a metric analysis module of the processing server, one or more metrics based on the transaction data included in each transaction data entry of the identified subset of transaction data entries, wherein each of the one or more metrics corresponds to one of the one or more requested metrics and is representative of business and/or industry performance; and electronically transmitting, by a transmitting device of the processing server, a data signal superimposed with data comprising the identified one or more metrics in response to the metric request.

A system for analysis of metrics based on stored data sets a specially programmed processing server comprising a transaction database, a receiving device, an identification module, a querying module, a metric analysis module, and a transmitting device. The transaction database is configured to store a plurality of transaction data entries, wherein each transaction data entry is a structured data set that includes data related to an electronic transaction including a plurality of data values storing data including at least an account identifier and a category code associated with a recipient of the electronic transaction and transaction data. The receiving device is configured to receive an electronic data signal superimposed with data comprising a metric request, wherein the metric request is related to a service provider and includes a plurality of data values storing data including at least one or more requested metrics and business data, the business data including data related to one or more customers of the related service provider. The identification module is configured to identify (i) a specific category code, or (ii) one or more account identifiers based on at least the business data included in the metric request. The querying module is configured to execute a query on the transaction database to identify a subset of transaction data entries where (i) the included account identifier corresponds to one of the one or more account identifiers, or (ii) the included category code corresponds to the specific category code. The metric analysis module is configured to identify one or more metrics based on the transaction data included in each transaction data entry of the identified subset of transaction data entries, wherein each of the one or more metrics corresponds to one of the one or more requested metrics and is representative of business and/or industry performance. The transmitting device is configured to electronically transmit a data signal superimposed with data comprising the identified one or more metrics in response to the metric request.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for analyzing performance metrics for a service provider based on consumer data in accordance with exemplary embodiments.

FIG. 2 is a block diagram illustrating the processing server of FIG. 1 for predicting and analyzing service provider performance based on transaction data for business-customers in accordance with exemplary embodiments.

FIG. 3 is a block diagram illustrating the transaction database of FIG. 2 for storing transaction data for use in predicting and analyzing service provider performance in accordance with exemplary embodiments.

FIG. 4 is a flow diagram illustrating a process for analyzing service provider performance metrics based on consumer transaction data using the system of FIG. 1 in accordance with exemplary embodiments.

FIG. 5 is a flow diagram illustrating a process for identifying service provider performance metrics based on stored transaction data sets using the processing server of FIG. 2 in accordance with exemplary embodiments.

FIG. 6 is a flow chart illustrating an exemplary method for analysis of metrics based on stored data sets in accordance with exemplary embodiments.

FIG. 7 is a flow diagram illustrating the processing of a payment transaction in accordance with exemplary embodiments.

FIG. 8 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require any special knowledge in offered products. In some embodiments, an entity involved in a single transaction may be considered a merchant. In some instances, as used herein, the term “merchant” may refer to an apparatus or device of a merchant entity.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing may be optional and/or may be performed in a different order.

### System for Analyzing Service Provider Metrics

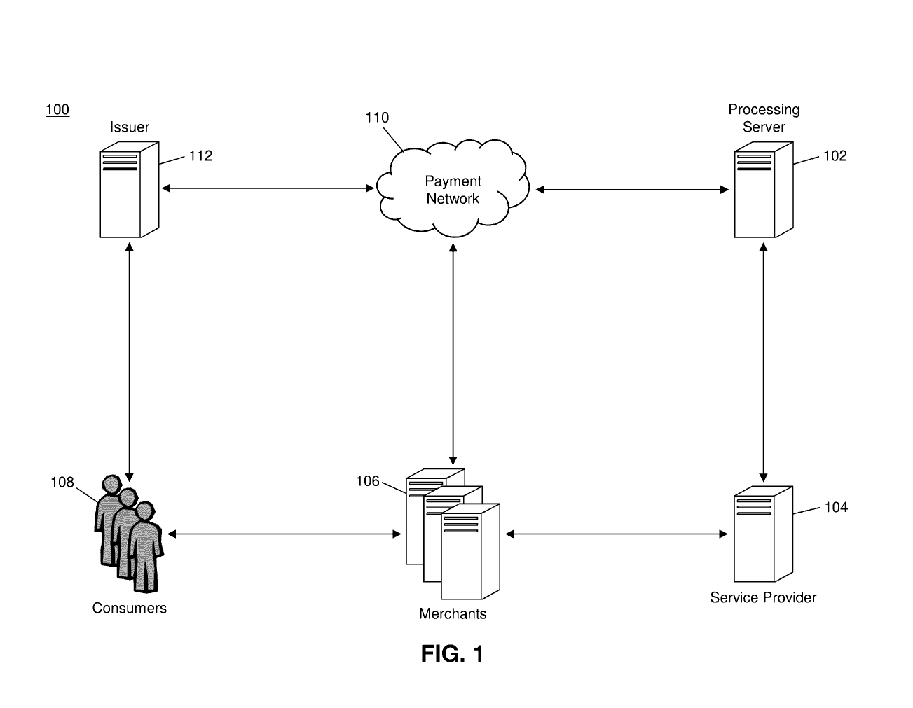

FIG. 1 illustrates a system 100 for the analysis and prediction of metrics for service provider performance based on consumer payment transactions involving business-customers of the service provider.

The system 100 may include a processing server 102. The processing server 102, discussed in more detail below, may be configured to identify performance metrics and predict future performance for a service provider 104 based on consumer transactions involving customers of the service provider 104 and as associated with an industry related to the service provider 104. The service provider 104 may conduct business with a plurality of different merchants 106 as customers of the service provider 104. The merchants 106 may, for instance, purchase goods or services from the service provider 104 for use in providing their own goods or services to consumers 108. For example, the service provider 104 may be a paper goods business that provides paper products to merchant restaurants, which may in turn sell food and dining experiences to consumers 108. In another example, the service provider 104 may be a laundry service that launders uniforms, linens, etc. for merchant hotels, restaurants, etc.

The merchants 106 may conduct payment transactions with consumers 108. As part of the payment transactions, the consumers 108 may provide payment details to the respective merchant 106 that are associated with a transaction account to fund the payment transaction. For instance, a consumer 108 may present a payment card or other payment instrument associated with a transaction account issued to the consumer 108 by an issuer 112. The issuer 112 may be a financial institution, such as an issuing bank, or other entity configured to operate, own, manage, or otherwise be associated with transaction accounts for use in funding payment transactions. Payment cards or other payment instruments issued to a consumer 108 that correspond to a transaction account may be physical instruments (e.g., a physical payment card including a magnetic stripe, integrated circuit chip, or other data storage) or virtual instruments (e.g., virtual payment cards stored in electronic wallet application programs or other data storage methods in computing devices) that store, are encoded with, or otherwise configured to convey payment details associated with the related transaction account.

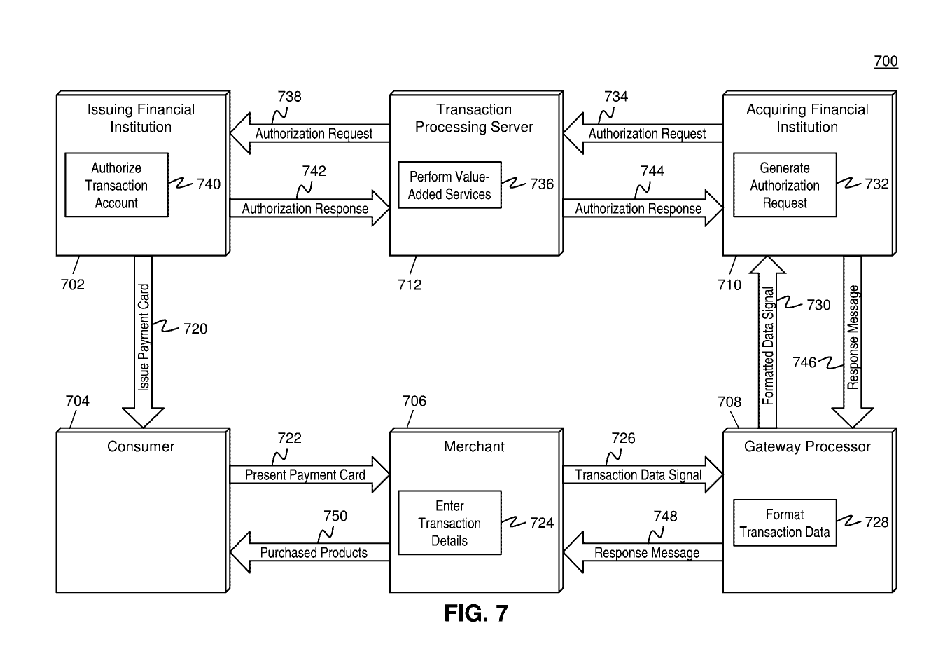

As part of the conducting of a payment transaction, the consumer 108 may convey payment details to the merchant 106 for the corresponding transaction account using a suitable method. For instance, the merchant 106 may use a point of sale device configured to read payment details stored or encoded in a physical payment card, may use an optical reading device to read payment details encoded in a machine-readable code, may use a receiving device to receive a communication comprising payment details via near field communication from a computing device, etc. The merchant 106 may receive the payment details and submit the payment details and additional transaction data to a payment network 110 for processing of the payment transaction. The payment network 110 may process the payment transaction using traditional methods and systems, which may include the exchange of one or more messages between the issuer 112 and/or merchants 106. Additional detail regarding the transmission of transaction details and transaction messages via payment rails involving a payment network 110, issuers 112, and merchants 106 are discussed below with respect to the process 700 illustrated in FIG. 7.

The processing server 102 may be configured to receive transaction data from payment transactions involving merchants 106 and consumers 108 from the payment network 110. In some embodiments, the payment network 110 may transmit transaction data to the processing server 102 via the payment rails, such as by providing transaction messages for the payment transactions to the processing server 102. Transaction messages may be data messages specially formatted pursuant to one or more standards governing the exchange of financial transaction messages, such as the International Organization for Standardization's ISO 8583 standard, that include data elements configured to store data as set forth in the associated standard(s). In some instances, transaction messages or transaction data may be transmitted using an alternative, yet suitable communication network, such as the Internet, a local area network, a wireless area network, a radio frequency network, etc.

In some embodiments, the processing server 102 may be a part of the payment network 110. In such embodiments, the payment network 104 may provide transaction data to the processing server 102 using internal communication methods and protocols. In some instances, the processing server 102 may be configured to perform processing functions of the payment network 110 for processing payment transactions. In such instances, the processing server 102 may receive transaction data from merchants 106 or other entities, such as gateway processors, acquiring financial institutions, etc., as part of the processing of payment transactions. In some embodiments, the payment network 110 may be configured to process transactions involving the service provider 104 and merchants 106. In such embodiments, the processing server 102 may receive transaction data for the transactions involving the service provider 104 and merchants 106 in addition to transaction data for transactions involving the merchants 106 and consumers 108.

Transaction data received from the payment network 110 or during the processing of payment transactions may include at least an account identifier and a category code for each payment transaction. The account identifier may be a unique value associated with a transaction account used to fund the related payment transaction, such as a primary account number. The category code may be a value associated with the merchant 106 involved in the payment transaction that may be indicative of an industry, category, or other organizational criteria associated with the merchant 106. Additional data included in the transaction data may include, for example, an account number or identification number associated with the merchant 106 involved in the transaction, a transaction time, a transaction data, a geographic location, etc.

The processing server 102 may be configured to analyze transaction data for payment transactions involving merchants 106 associated with the service provider 104 to analyze performance metrics for performance of the service provider 104. In some instances, the service provider 104 may electronically transmit a data signal to the processing server 102 using a suitable communication network, where the data signal is superimposed with data representing a metric request. The metric request may indicate one or more metrics of service performance requested from the processing server 102. In some embodiments, the metric request may also include information identifying the service provider 104 for whom the metrics are requested, or the merchants 106 and/or merchant industry that the service provider 104 is associated with, suitable for use by the processing server 102 in identifying associated transaction data.

For example, the service provider 104 may include a merchant identifier associated with the service provider 104 in the metric request. The processing server 102 may parse (e.g., deconstruct into constituent data elements and values) the metric request to obtain the merchant identifier superimposed therewith. The processing server 102 analyzes received transaction data to identify payment transactions that include the merchant identifier provided by the service provider 104, thus identifying payment transactions involving the service provider 104. The processing server 102 may then analyze the transaction data for the identified payment transactions to identify merchant identifiers associated with the merchants 106 transacting with the service provider 104, which may be indicated as a buyer, payee, giver, etc. for the payment transaction. In some instances, the processing server 102 may analyze the transaction data to identify a merchant category code associated with the service provider 104 based on a frequency of the category code in the transaction data. In other examples, the metric request may directly include the merchant identifiers associated with the merchants 106 or the category code associated with the service provider 104.

Once the merchant identifying information (e.g., merchant identifier, account identifier, category code, etc.) has been identified, the processing server 102 may identify associated transaction data. The associated transaction data may be transaction data for payment transactions that includes a merchant identifier, category code, etc. that corresponds to the data identified as a result of the received and parsed metric request. In some instances, the transaction data may be filtered by one or more criteria, such as may be included in the metric request. For example, the processing server 102 may only identify transaction data for payment transactions that occurred during a predetermined period of time. The processing server 102 may then identify the requested metrics based on the identified associated transaction data. The requested metrics may be identified using the additional data stored in the transaction data for each of the identified payment transactions. The processing server 102 may electronically transmit a data signal back to the service provider 104 that is superimposed with the requested metrics.

In some embodiments, the processing server 102 may be configured to predict future performance for the service provider 104 based on predicted future performance of the merchants 106 and/or merchant industry. The future performance of the merchants 106 and/or merchant industry may be predicted by the processing server 102 based on transaction data (e.g., transaction amounts, average ticket size, transaction frequency, etc.) for transactions involving the merchants 106 and consumers 108. The processing server 102 may then utilize the predicted merchant performance for the service provider 104 in predicting future performance of the service provider 104. For example, if the processing server 102 identifies that the merchants 106 of the service provider 104 have been or will be doing greater business with consumers 108, then the processing server 102 may predict that the service provider's 104 business with the merchants 106 will increase as a result. For instance, an increase in hotel occupancy rates for the merchants 106 (e.g., predicted or actually occurring recent to the determination) may result in an expected increase in laundry services for the service provider 104 to provide to the merchants 106.

Accordingly, methods and systems discussed herein may enable the processing server 102 to provide analysis and predictions of performance for a service provider 104 that take into account transactions conducted between consumers 108 and merchants 106 either directly associated with the service provider 104 (e.g., as customers of the service provider 104) or associated with an industry related to the service provider 104. The use of transaction data for transactions between merchants 106 and consumers 108 may ensure accuracy regarding the performance of merchants 106, but may also enable the analysis of such data without requiring modification to the systems of the merchants 106. Thus, the processing server 102 may analyze and provide metrics to service providers 104 by the collection of transaction data via a payment network 110 without detriment to the merchants 106. As such, the unique and specially configured methods and systems discussed herein may provide for a technical solution for service providers 104 that cannot be provided using traditional systems.

### Processing Server

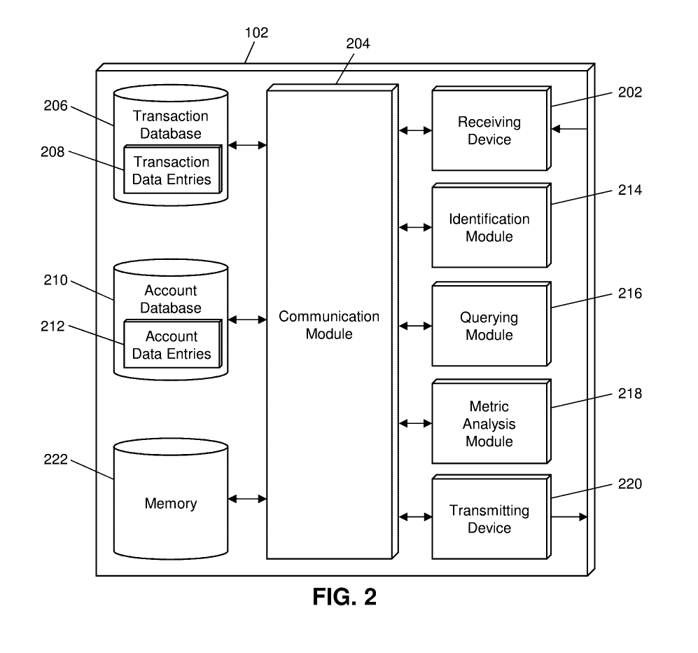

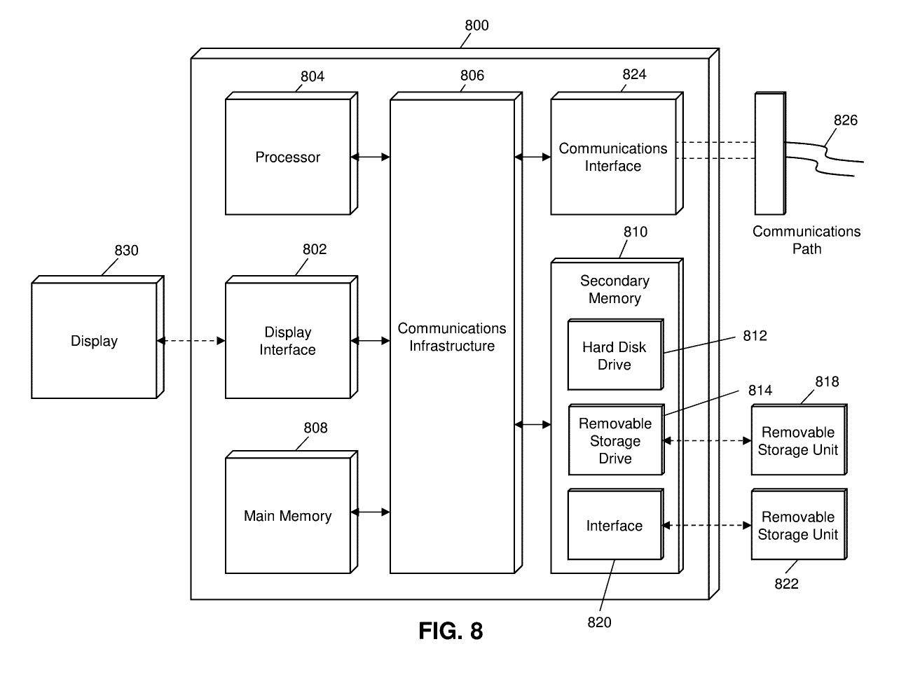

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive of all possible configurations of the processing server 102 suitable for performing the functions as discussed herein. For example, the computer system 800 illustrated in FIG. 8 and discussed in more detail below may be a suitable configuration of the processing server 102.

The processing server 102 may include a receiving device 202. The receiving device 202 may be configured to receive data over one or more networks via one or more network protocols. In some embodiments, the receiving device 202 may be configured to receive data over the payment rails, such as using specially configured infrastructure associated with payment networks 110 for the transmission of transaction messages that include sensitive financial data and information. In some instances, the receiving device 202 may also be configured to receive data from service providers 104, the payment network 110, merchants 106, and other entities via alternative networks, such as the Internet. In some embodiments, the receiving device 202 may be comprised of multiple devices, such as different receiving devices for receiving data over different networks, such as a first receiving device for receiving data over payment rails and a second receiving device for receiving data over the Internet. The receiving device 202 may receive electronically data signals that are transmitted, where data may be superimposed on the data signal and decoded, parsed, read, or otherwise obtained via receipt of the data signal by the receiving device 202. In some instances, the receiving device 202 may include a parsing module for parsing the received data signal to obtain the data superimposed thereon.

The receiving device 202 may be configured to receive transaction data from the payment network 110. The transaction data may be transmitted as specially formatted transaction messages via the payment rails from the payment network 110, or may be included in data entries superimposed on data signals electronically transmitted by the payment network 110 using the payment rails or another suitable communication network. The transaction data may include at least an account identifier and a category code associated with a recipient (e.g., the merchant 106) in the associated payment transaction. The receiving device 202 may also receive data signals superimposed with metric requests, such as from service providers 104. The receiving device 202 or another device may include a parsing module configured to parse received metric requests to obtain information included therein, which may include one or more requested metrics, an account identifier associated with a service provider 104, a category code for requested metrics, and/or one or more account identifiers associated with merchant 106 customers of a service provider 104.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc.

The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device. For example, as illustrated in FIG. 2, the processing server 102 may include an identification module 214, a querying module 216, and a metric analysis module 218, which may comprise a processing device of the processing server 102, such as may be incorporated in one or more processors having one or more processor cores. In some instances, the modules may be implemented using a combination of hardware (e.g., of the processor) and software, which may comprise application programs having program code stored in the processing server 102 and executed by a processor. It will be apparent to persons having skill in the relevant art that the processing server 102 may include additional modules and/or engines suitable for performing the functions discussed herein, such as a parsing module for parsing data signals received by the receiving device 202 into usable data (e.g., into a module for processing such data), a transaction processing module for initiating and/or processing payment transactions, etc.

The processing server 102 may also include a transaction database 206. The transaction database 206 may be configured to store a plurality of transaction data entries 208 using a suitable data storage format and schema. Each transaction data entry 208 may be a structured data set that includes data related to an electronic payment transaction, which may include at least an account identifier and a category code associated with a recipient (e.g., a merchant 106) of the related transaction. The account identifier may be associated with a transaction account used to receive funds as part of the processing of the related payment transaction. The category code may be a value associated with a category, industry, or other organizational data type of the recipient of the related transaction. In some instances, the value of the category code may be based on specific standards, such as for a merchant category code. Transaction data entries 208 may also include additional transaction data associated with the related payment transaction, such as a transaction amount, transaction time, transaction date, geographic location, consumer data, issuer data, merchant data, acquirer data, product data, reward data, loyalty data, offer data, etc.

In some embodiments, the processing server 102 may also include an account database 210. The account database 210 may be configured to store a plurality of account data entries 212 using a suitable data storage format and schema. Each account data entry 212 may be a structured data set that includes data related to a transaction account, such as may be used for the payment or receipt of funds in payment transactions, and/or related to a merchant 106 or service provider 104. Each account data entry 212 may include an account identifier associated with the related transaction account, merchant 106, or service provider 104, and may also include a category code associated with the related account or entity and/or one or more related account identifiers. Related account identifiers may be account identifiers related to transaction accounts or merchants 106 that are related to the transaction account or entity related to the respective account data entry 212. For example, the account data entry 212 may be related to a service provider 104, and the related account identifiers included therein may each be associated with a merchant 106 customer of the service provider 104.

The processing server 102 may further include an identification module 214. The identification module 214 may be configured to identify data included in and/or parsed from metric requests received by the receiving device 202. The identification module 214 may receive a metric request and desired data values as input, may identify the desired data values in the metric request, and may output the data values, such as for use by another module or device of the processing server 102. For example, the identification module 214 may be configured to identify a category code or one or more account identifiers using business data included in a specific metric request. In some instances, the category code or account identifiers may be included directly in the metric request. In other instances, the business data may include information suitable for use by the identification module 214 in identifying a category code or account identifiers for use in identifying metrics indicated in the metric request. For instance, in one example, the business data may include an account identifier associated with a service provider 104. In such an example, the identification module 214 may, using one or more additional modules of the processing server 102, identify a category code or other related account identifiers associated with the account identifier included in the business data, such as by using an account data entry 212 in the account database 210 that includes the account identifier or by identifying account identifiers in transaction data entries 208 in the transaction database 206 that also include the account identifier included in the business data.

Once the identification module 214 has identified the category code and/or account identifiers that are associated with a service provider 104 or related industry, a querying module 216 of the processing server 102 may execute a query on the transaction database 206 to identify a plurality of transaction data entries 208 that include related transaction data. The querying module 216 may be configured to receive a query string and/or one or more data values as input, may execute a query on a database to identify data as indicated in the query, and may output the identified data entries and/or values. The querying module 216 may, for instance, identify transaction data entries 208 that include the category code and/or account identifiers identified by the identification module 214.

The processing server 102 may also include a metric analysis module 218. The metric analysis module 218 may be configured to receive transaction data as input, may identify, calculate, or otherwise determine one or more metrics (e.g., which may also be specifically requested as input to the metric analysis module 218) using the transaction data, and may output the one or more metrics. The metrics may include, for example, number of transactions, transaction frequency, average ticket size, number of unique consumers 108, number of return consumers 108, market share, performance over time, predicted future performance, etc., and combinations thereof. The metrics may be representative of business performance for each business (e.g., merchant 106) associated with one of the account identifiers, or may be representative of industry performance for an industry associated with a category code. The metric analysis module 218 may use the transaction data identified by the querying module 216 to identify one or more metrics as requested in the received metric request.

The processing server 102 may further include a transmitting device 206. The transmitting device 206 may be configured to transmit data over one or more networks via one or more network protocols. In some embodiments, the transmitting device 206 may be configured to transmit data over the payment rails, such as using specially configured infrastructure associated with payment networks 110 for the transmission of transaction messages that include sensitive financial data and information, such as identified payment credentials. In some instances, the transmitting device 206 may be configured to transmit data to service providers 104, payment networks 110, issuers 112, merchants 106, and other entities via alternative networks, such as the Internet. In some embodiments, the transmitting device 206 may be comprised of multiple devices, such as different transmitting devices for transmitting data over different networks, such as a first transmitting device for transmitting data over the payment rails and a second transmitting device for transmitting data over the Internet. The transmitting device 206 may electronically transmit data signals that have data superimposed that may be parsed by a receiving computing device. In some instances, the transmitting device 206 may include one or more modules for superimposing, encoding, or otherwise formatting data into data signals suitable for transmission.

The transmitting device 220 may be configured to electronically transmit data signals superimposed with identified metrics via a suitable communication network. The data signals may be transmitted to service providers 104 or other entities in response to an associated metric request. The transmitting device 220 may also be configured to electronically transmit data signals superimposed with transaction data requests to payment networks 110, such as via the payment rails or an alternative communication network. Transaction data requests may be requests for transaction data, and may include account identifiers, category codes, geographic locations, times, dates, etc., for which transaction data may be requested.

The processing server 102 may also include a memory 222. The memory 222 may be configured to store data for use by the processing server 102 in performing the functions discussed herein. The memory 222 may be configured to store data using suitable data formatting methods and schema and may be any suitable type of memory, such as read-only memory, random access memory, etc. The memory 222 may include, for example, encryption keys and algorithms, communication protocols and standards, data formatting standards and protocols, program code for modules and application programs of the processing unit 204, and other data that may be suitable for use by the processing server 102 in the performance of the functions disclosed herein as will be apparent to persons having skill in the relevant art.

### Transaction Database

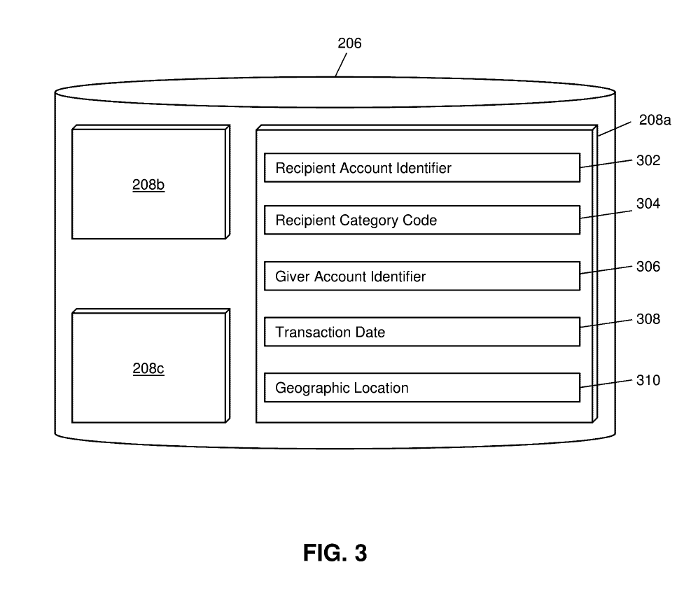

FIG. 3 illustrates the transaction database 206 of the processing server 102 for the storage of transaction data in transaction data entries 208. The transaction database 206 may store a plurality of transaction data entries 208, illustrated in FIG. 3 as transaction data entries 208a, 208b, and 208c, using any suitable data storage format and schema. For example, the transaction database 206 may be a relational database that utilizes structured query language for the storage, identification, modifying, updating, accessing, etc. of structured data sets stored therein.

Each transaction data entry 208 may be related to an electronic payment transaction (e.g., processed by the payment network 110) and may include a recipient account identifier 302 and recipient category code 304. The recipient account identifier 302 and recipient category code 304 may be associated with a recipient of the related payment transaction, such as the merchant 106 or service provider 104, which may be the recipient of funds for the related payment transaction. For instance, in transactions involving service providers 104 and merchants 106, the service provider 104 may be the recipient, and in transactions involving merchants 106 and consumers 108, the merchant 106 may be the recipient. The recipient account identifier 304 may be a unique value associated with the recipient and/or a transaction account of the recipient. The recipient category code 304 may be a value associated with an industry or other categorization of the recipient, such as a merchant category code.

In some instances, a transaction data entry 208 may also include a giver account identifier 306. The giver account identifier 306 may be associated with a giver in the payment transaction, which may be an entity that provides funds to the recipient of the payment transaction, such as a consumer 108 or merchant 106. The giver account identifier 306 may be a unique value associated with the giver and/or a transaction account of the giver for the payment transaction. In instances where the giver may be a merchant 106 and recipient a service provider 104, the giver account identifier 306 may be used by the identification module 214 to identify merchants 106 that are customers of a service provider 104, for use in identifying performance metrics for the service provider 104 (e.g., based on transaction data for merchant 106 customers of the service provider 104).

Transaction data entries 208 may also include additional transaction data related to the payment transaction, such as a transaction date 308 and geographic location 310. The transaction date 308 may be a date at which the related payment transaction was conducted (e.g., initiated, authorized, processed, cleared, settled, etc.). The transaction date 308 may be used, for example, in the identification of performance metrics. For instance, the metric analysis module 218 of the processing server 102 may identify metrics over a specific period of time, may identify metrics related to changes in performance over time, may identify metrics that estimate future performance, etc., which may utilize transaction dates 308 for payment transactions. The geographic location 310 may be a geographic location for the payment transaction, such as a physical location for an in-person transaction or a location of the giver and/or recipient for a remote (e.g., telephone, Internet, mail order, etc.) transaction. The metric analysis module 218 may use the geographic location 310 in the identification of metrics, such as in determining industry performance in different geographic areas.

### Process for Identifying Service Provider Performance Metrics

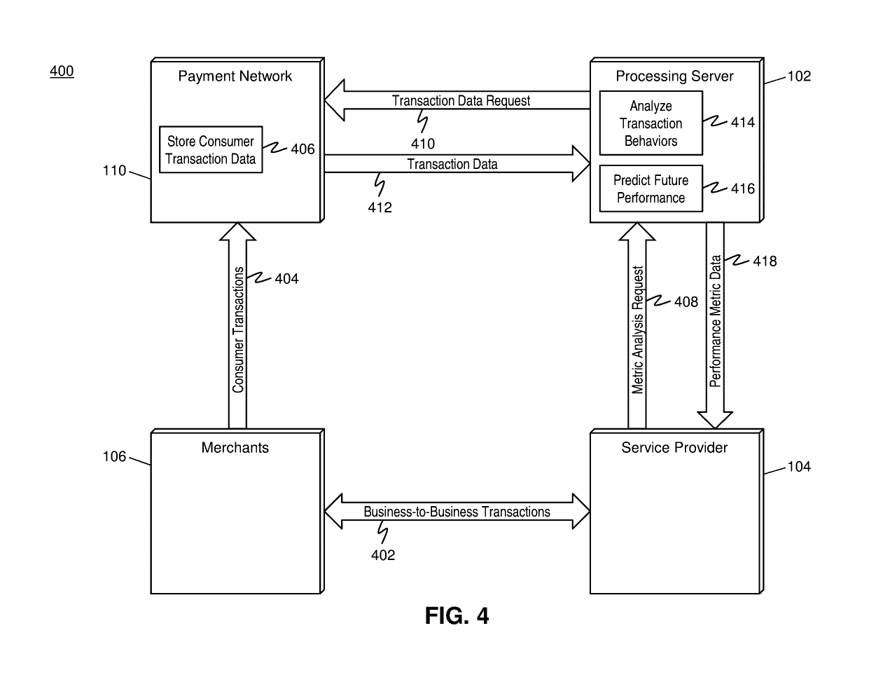

FIG. 4 illustrates a process 400 for the identification of performance metrics for performance of a service provider 104 in the system 100 based on transaction data for payment transactions involving merchant 106 customers of the service provider 104.

In step 402, the service provider 104 may conduct a plurality of business-to-business transactions with a plurality of merchants 106 that may be customers of the service provider 104. In some embodiments, the business-to-business transactions may be processed by the payment network 110, and the corresponding transaction data provided to the processing server 102. In many instances, the merchant 106 customers of the service provider 104 may each be associated with a common merchant category code. In step 404, each of the plurality of merchants 106 may conduct payment transactions with various consumers 108. The payment transactions involving the consumers 108 may be processed by the payment network 110 using traditional methods and systems.

In step 406, the payment network 110 may store transaction data for the consumer payment transactions involving the merchants 106 and consumers 108. In some instances, the transaction data may be stored via the transaction messages received during processing of the payment transactions. The transaction messages may be formatted pursuant to one or more standards, such as the ISO 8583 standard, and include a plurality of data elements. Data included in the transaction data may include, for instance, at least a recipient account identifier 302 and recipient category code 304.

In step 408, the service provider 104 may electronically transmit a data signal to the processing server 102 via a suitable communication network that is superimposed with a metric analysis request. The metric analysis request may include at least one or more requested metrics and business data. The receiving device 202 of the processing server 102 may receive the data signal and may parse the data signal to obtain the metric analysis request superimposed therewith and the data included therein. In step 410, the transmitting device 220 of the processing server 102 may electronically transmit a data signal to the payment network 110 via the payment rails or an alternative communication network that is superimposed with a transaction data request. The transaction data request may include at least a category code or one or more account identifiers for which transaction data is requested. The category code or one or more account identifiers may be identified using the identification module 214 of the processing server 102, which may utilize the business data parsed from the metric request. In some instances, the business data may directly include the category code and/or account identifier(s) included in the transaction data request. In other instances, the identification module 214 may identify the category code or account identifier(s) as stored in an account data entry 212 in the account database 210 related to the service provider 104 as identified by the querying module 216.

The payment network 110 may receive the transaction data request, and may identify the associated transaction data related to consumer payment transactions involving the merchants 106 and consumers 108 and provide the transaction data to the processing server 102, in step 412. The transaction data may be superimposed on one or more data signals electronically transmitted to the processing server 102 via the payment rails or other suitable communication network. In some instances, the payment network 110 may electronically transmit the transaction messages related to the payment transactions corresponding to the requested transaction data.

In step 414, the metric analysis module 218 of the processing server 102 or other suitable module may analyze transaction behaviors based on the received transaction data. Transaction behaviors may be metrics and other measurements related to the analysis of transaction, such as may be used to summarize behaviors of the consumers 108 and/or merchants 106 involved in the related payment transactions. Transaction behaviors may include, for example, propensities for consumers 108 to conduct payment transactions at specific merchants 106, with specific merchant industries, at specific geographic locations, in specific geographic areas, for specific products, for specific types of products, inside or outside specific transaction amounts and ranges, at specific times, on specific days, on specific days of the week, etc. Transaction behaviors may also include, for instance, numbers of transactions, transaction frequency, average ticket size, etc.

In step 416, the metric analysis module 218 may identify one or more metrics related to predictions of future performance for the service provider 104, as may be requested in the one or more requested metrics parsed from the received metric analysis request. The future performance may be based on the analyzed transaction behaviors and transaction dates 308 associated thereto. In some instances, the metric analysis module 218 may analyze performance of other, related service providers 108 (e.g., in the same or a similar industry, in the same or a similar geographic area, with the same or similar merchant 106 customers, etc.) for use in predicting future performance of the service provider 104. In step 418, the transmitting device 220 of the processing server 102 may electronically transmit a data signal superimposed with the one or more requested metrics to the service provider 104, as a response to the earlier received metric analysis request.

### Process for Analysis of Service Provider Performance Metrics

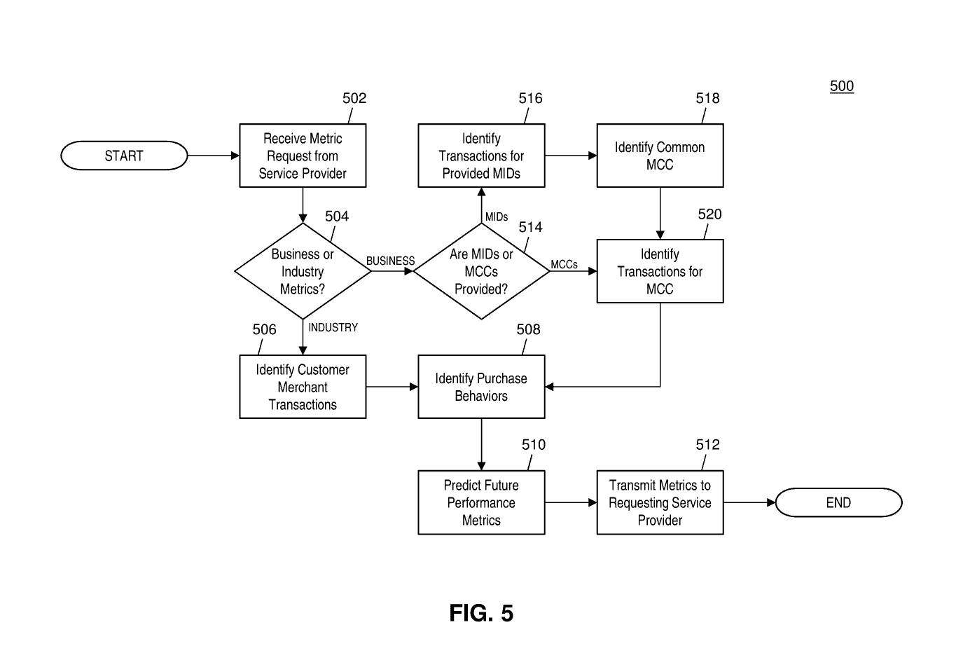

FIG. 5 illustrates a process 500 for the identification and analysis of performance metrics for performance of a service provider 104 using the processing server 102.

In step 502, the receiving device 202 of the processing server 102 may receive a data signal electronically transmitted by a service provider 104 that is superimposed with a metric request. The receiving device 202 or a separate module of the processing server 102 may parse the data signal to obtain the metric request and data included therein, which may include at least one or more requested metrics and business data. In step 504, the processing server 102 may determine if the one or more requested metrics are business metrics (e.g., associated with merchant 106 customers of the service provider 104) or industry metrics (e.g., associated with a merchant industry related to the service provider 104). The determination may be made based on the one or more requested metrics parsed from the received metric request.

If the one or more requested metrics includes industry metrics, then, in step 506, the querying module 216 of the processing server 102 may execute a query on the transaction database 206 to identify transaction data entries 208 for payment transactions associated with the industry. The transaction data entries 208 may include recipient category codes 304 that correspond to the specific industry. The category code that corresponds to the specific industry may be identified for use in the query by the identification module 214 of the processing server 102, which may identify the category code from the business data parsed from the received metric request. In some instances, the business data may directly include the category code. In other instances, the business data may include an account identifier associated with the service provider 104. In such an instance, the querying module 216 may execute a query on the account database 210 to identify an account data entry 212 associated with the service provider 104 that includes the account identifier, and the identification module 214 may identify a category code stored therein.

In step 508, the metric analysis module 218 of the processing server 102 may identify purchase behaviors for the industry based on the transaction data included in the identified transaction data entries 208. In step 510, the metric analysis module 218 may identify future performance metrics for the industry that correspond to the one or more requested metrics, based on the identified purchase behaviors. In step 512, the transmitting device 220 of the processing server 102 may electronically transmit a data signal superimposed with the identified metrics to the service provider 104, as a response to the received metric request.

If, in step 504, the processing server 102 determines that the one or more requested metrics includes any business metrics, then the process 500 may proceed to step 514, where the identification module 214 or other module of the processing server 102 may determine if the business data parsed from the received metric request includes any merchant identifiers (MIDs) (e.g., account identifiers associated with merchant 106 customers of the service provider 104) or any merchant category codes (MCCs). In some instances, the identification module 214 may be configured to identify MIDs or MCCs using data included in the business data, such as by identifying if an account data entry 212 associated with the service provider (e.g., and identified by the querying module 216 using an account identifier included in the business data) includes MIDs or MCCs associated with the service provider 104.

If MIDs are identified, then, in step 516, the querying module 216 of the processing server 102 may execute a query on the transaction database 206 to identify transaction data entries 208 that include recipient account identifiers 302 that correspond to the identified MIDs. In step 518, the identification module 214 may identify one or more common recipient category codes 304 included in each of the identified transaction data entries 208, which may thereby correspond to one or more industries or other categorizations of the merchant 106 customers of the service provider 104. In some instances, an MCC corresponding to the merchant 106 customers of the service provider 104 may be determined based on the most common MCC appearing in the transaction data entries 208.

In step 520, the querying module 216 may execute a query on the transaction database 206 to identify transaction data entries 208 associated with the one or more merchant categories associated with the customers of the service provider 104, where the recipient category code 304 included in the transaction data entry 208 corresponds to the MCC identified by the identification module 214 from the business data, in step 514, or from the transaction data entries 208, in step 518. Once the transaction data entries 208 associated with the one or more MCCs are identified, the process 500 may proceed to step 508, where the metric analysis module 218 identifies purchase behaviors based on the transaction data associated with the individual merchant(s) 106 and associated MCCs, and to step 510, where the metric analysis module 218 identifies future performance metrics based thereon. In step 512, the transmitting device 220 of the processing server 102 may electronically transmit a data signal superimposed with the identified metrics to the service provider 104, as a response to the received metric request.

### Exemplary Method for Analysis of Metrics Based on Stored Data Sets

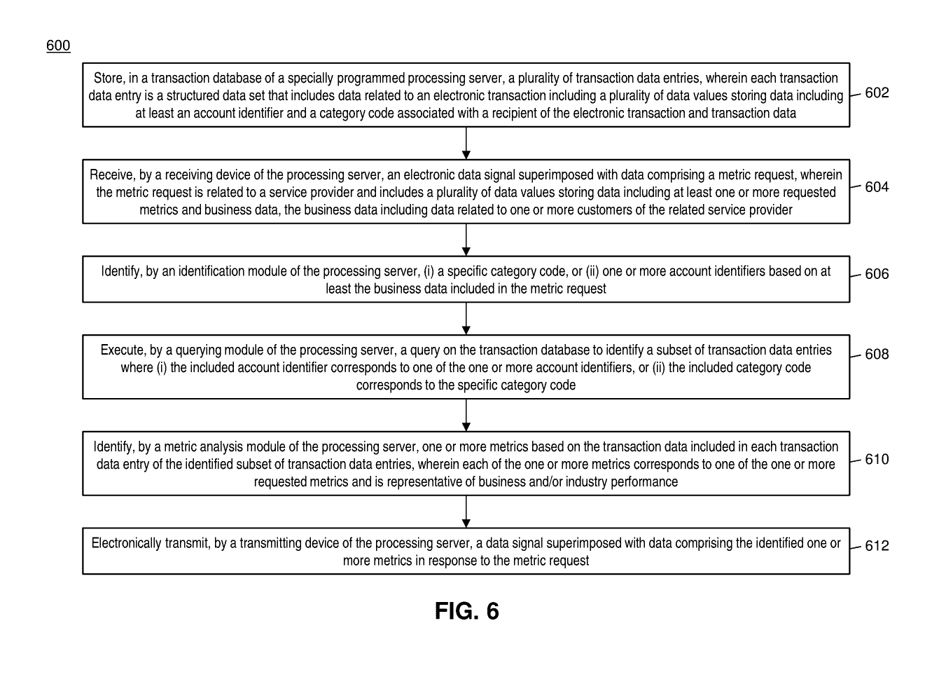

FIG. 6 illustrates a method 600 for the analysis of metrics related to performance of a service provider based on stored data sets of transaction data corresponding to electronic payment transactions involving merchant customers and/or an industry related to the service provider.

In step 602, a plurality of transaction data entries (e.g., transaction data entries 208) may be stored in a transaction database (e.g., the transaction database 206) of a specially programmed processing server (e.g., the processing server 102), wherein each transaction data entry is a structured data set that includes data related to an electronic transaction including a plurality of data values storing data including at least an account identifier and a category code associated with a recipient of the electronic transaction and transaction data. In step 604, an electronic data signal superimposed with data comprising a metric request may be received by a receiving device (e.g., the receiving device 202) of the processing server, wherein the metric request is related to a service provider (e.g., the service provider 104) and includes a plurality of data values storing data including at least one or more requested metrics and business data, the business data including data related to one or more customers (e.g., merchants 106) of the related service provider.

In step 606, an identification module (e.g., the identification module 214) of the processing server may identify (i) a specific category code, or (ii) one or more account identifiers based on at least the business data included in the metric request. In step 608, a querying module (e.g., the querying module 216) of the processing server may execute a query on the transaction database to identify a subset of transaction data entries where (i) the included account identifier corresponds to one of the one or more account identifiers, or (ii) the included category code corresponds to the specific category code.

In step 610, one or more metrics may be identified by a metric analysis module (e.g., the metric analysis module 218) of the processing server based on the transaction data included in each transaction data entry of the identified subset of transaction data entries, wherein each of the one or more metrics corresponds to one of the one or more requested metrics and is representative of business and/or industry performance. In step 612, a data signal superimposed with data comprising the identified one or more metrics may be electronically transmitted by a transmitting device (e.g., the transmitting device 220) of the processing server in response to the metric request.

In one embodiment, the business data may include the one or more account identifiers, and identifying the one or more account identifiers may include identifying, in the business data included in the metric request, the one or more account identifiers. In some embodiments, the business data may include the specific category code, and identifying the specific category code may include identifying, in the business data included in the metric request, the specific category code.

In one embodiment, the business data may include a specific account identifier associated with the related service provider, and identifying the one or more account identifiers may include: executing, by the querying module of the processing server, a query on the transaction database to identify a group of transaction data entries where the account identifier associated with the recipient corresponds to the specific merchant identifier; and identifying, by the identification module of the processing server, the one or more account identifiers by identifying, in each of the identified group of transaction data entries, an account identifier associated with a giver of the related electronic transaction. In some embodiments, the business data may include a specific account identifier associated with the related service provider, and identifying the specific category code may include: executing, by the querying module of the processing server, a query on the transaction database to identify a group of transaction data entries where the account identifier associated with the recipient corresponds to the specific account identifier; and identifying, by the identification module of the processing server, the specific category code as corresponding to the category code associated with a payer included in a majority of the group of transaction data entries.

In one embodiment, each transaction data entry stored in the transaction database may include a transaction date. In a further embodiment, the transaction date included in each transaction data entry in the identified subset may be within a period of time, and the metric request may further include the period of time. In another further embodiment, the one or more metrics may be further based on the transaction date included in each transaction data entry of the identified subset, and the one or more metrics may include a prediction of future performance.

In some embodiments, the method 600 may further include: storing, in an account database (e.g., the account database 210) of the processing server, a plurality of account data entries (e.g., account data entries 212), wherein each account data entry is a structured data set that includes data related to an account including a plurality of data values storing data including at least an account identifier and (i) a related category code, or (ii) one or more related account identifiers, wherein the business data further includes a specific account identifier, and (i) the specific category code corresponds to the related category code, or (ii) the one or more account identifiers corresponds to the one or more related account identifiers included in a specific account profile of the plurality of account profiles where the included account identifier corresponds to the specific account identifier. In one embodiment, the method 600 may also include: storing, in an account database of the processing server, a plurality of account data entries, wherein each account data entry is a structured data set that includes data related to an account including a plurality of data values storing data including at least a category code and a related category code, wherein the business data further includes a requester category code, and the specific category code corresponds to the related category code included in a specific account profile of the plurality of account profiles where the included category code corresponds to the requester category code.

### Payment Transaction Processing System and Process

FIG. 7 illustrates a transaction processing system and a process 700 for the processing of payment transactions in the system. The process 700 and steps included therein may be performed by one or more components of the system 100 discussed above, such as the merchants 106, issuers 112, service providers 104, consumers 108, processing server 102, and payment network 110. The processing of payment transactions using the system and process 700 illustrated in FIG. 7 and discussed below may utilize the payment rails, which may be comprised of the computing devices and infrastructure utilized to perform the steps of the process 700 as specially configured and programmed by the entities discussed below, including the transaction processing server 712, which may be associated with one or more payment networks configured to processing payment transactions. It will be apparent to persons having skill in the relevant art that the process 700 may be incorporated into the processes illustrated in FIGS. 4-6, discussed above, with respect to the step or steps involved in the processing of a payment transaction. In addition, the entities discussed herein for performing the process 700 may include one or more computing devices or systems configured to perform the functions discussed below. For instance, the merchant 704 may be comprised of one or more point of sale devices, a local communication network, a computing server, and other devices configured to perform the functions discussed below.

In step 720, an issuing financial institution 702 may issue a payment card or other suitable payment instrument to a consumer 704. The issuing financial institution may be a financial institution, such as a bank, or other suitable type of entity that administers and manages payment accounts and/or payment instruments for use with payment accounts that can be used to fund payment transactions. The consumer 704 may have a transaction account with the issuing financial institution 702 for which the issued payment card is associated, such that, when used in a payment transaction, the payment transaction is funded by the associated transaction account. In some embodiments, the payment card may be issued to the consumer 704 physically. In other embodiments, the payment card may be a virtual payment card or otherwise provisioned to the consumer 704 in an electronic format.

In step 722, the consumer 704 may present the issued payment card to a merchant 706 for use in funding a payment transaction. The merchant 706 may be a business, another consumer, or any entity that may engage in a payment transaction with the consumer 704. The payment card may be presented by the consumer 704 via providing the physical card to the merchant 706, electronically transmitting (e.g., via near field communication, wireless transmission, or other suitable electronic transmission type and protocol) payment details for the payment card, or initiating transmission of payment details to the merchant 706 via a third party. The merchant 706 may receive the payment details (e.g., via the electronic transmission, via reading them from a physical payment card, etc.), which may include at least a transaction account number associated with the payment card and/or associated transaction account. In some instances, the payment details may include one or more application cryptograms, which may be used in the processing of the payment transaction.

In step 724, the merchant 706 may enter transaction details into a point of sale computing system. The transaction details may include the payment details provided by the consumer 704 associated with the payment card and additional details associated with the transaction, such as a transaction amount, time and/or date, product data, offer data, loyalty data, reward data, merchant data, consumer data, point of sale data, etc. Transaction details may be entered into the point of sale system of the merchant 706 via one or more input devices, such as an optical bar code scanner configured to scan product bar codes, a keyboard configured to receive product codes input by a user, etc. The merchant point of sale system may be a specifically configured computing device and/or special purpose computing device intended for the purpose of processing electronic financial transactions and communicating with a payment network (e.g., via the payment rails). The merchant point of sale system may be an electronic device upon which a point of sale system application is run, wherein the application causes the electronic device to receive and communicated electronic financial transaction information to a payment network. In some embodiments, the merchant 706 may be an online retailer in an e-commerce transaction. In such embodiments, the transaction details may be entered in a shopping cart or other repository for storing transaction data in an electronic transaction as will be apparent to persons having skill in the relevant art.

In step 726, the merchant 706 may electronically transmit a data signal superimposed with transaction data to a gateway processor 708. The gateway processor 708 may be an entity configured to receive transaction details from a merchant 706 for formatting and transmission to an acquiring financial institution 710. In some instances, a gateway processor 708 may be associated with a plurality of merchants 706 and a plurality of acquiring financial institutions 710. In such instances, the gateway processor 708 may receive transaction details for a plurality of different transactions involving various merchants, which may be forwarded on to appropriate acquiring financial institutions 710. By having relationships with multiple acquiring financial institutions 710 and having the requisite infrastructure to communicate with financial institutions using the payment rails, such as using application programming interfaces associated with the gateway processor 508 or financial institutions used for the submission, receipt, and retrieval of data, a gateway processor 708 may act as an intermediary for a merchant 706 to be able to conduct payment transactions via a single communication channel and format with the gateway processor 708, without having to maintain relationships with multiple acquiring financial institutions 710 and payment processors and the hardware associated thereto. Acquiring financial institutions 710 may be financial institutions, such as banks, or other entities that administers and manages payment accounts and/or payment instruments for use with payment accounts. In some instances, acquiring financial institutions 710 may manage transaction accounts for merchants 706. In some cases, a single financial institution may operate as both an issuing financial institution 702 and an acquiring financial institution 710.

The data signal transmitted from the merchant 706 to the gateway processor 708 may be superimposed with the transaction details for the payment transaction, which may be formatted based on one or more standards. In some embodiments, the standards may be set forth by the gateway processor 708, which may use a unique, proprietary format for the transmission of transaction data to/from the gateway processor 708. In other embodiments, a public standard may be used, such as the International Organization for Standardization's ISO 8783 standard. The standard may indicate the types of data that may be included, the formatting of the data, how the data is to be stored and transmitted, and other criteria for the transmission of the transaction data to the gateway processor 708.

In step 728, the gateway processor 708 may parse the transaction data signal to obtain the transaction data superimposed thereon and may format the transaction data as necessary. The formatting of the transaction data may be performed by the gateway processor 708 based on the proprietary standards of the gateway processor 708 or an acquiring financial institution 710 associated with the payment transaction. The proprietary standards may specify the type of data included in the transaction data and the format for storage and transmission of the data. The acquiring financial institution 710 may be identified by the gateway processor 708 using the transaction data, such as by parsing the transaction data (e.g., deconstructing into data elements) to obtain an account identifier included therein associated with the acquiring financial institution 710. In some instances, the gateway processor 708 may then format the transaction data based on the identified acquiring financial institution 710, such as to comply with standards of formatting specified by the acquiring financial institution 710. In some embodiments, the identified acquiring financial institution 710 may be associated with the merchant 706 involved in the payment transaction, and, in some cases, may manage a transaction account associated with the merchant 706.

In step 730, the gateway processor 708 may electronically transmit a data signal superimposed with the formatted transaction data to the identified acquiring financial institution 710. The acquiring financial institution 710 may receive the data signal and parse the signal to obtain the formatted transaction data superimposed thereon. In step 732, the acquiring financial institution may generate an authorization request for the payment transaction based on the formatted transaction data. The authorization request may be a specially formatted transaction message that is formatted pursuant to one or more standards, such as the ISO 8783 standard and standards set forth by a payment processor used to process the payment transaction, such as a payment network. The authorization request may be a transaction message that includes a message type indicator indicative of an authorization request, which may indicate that the merchant 706 involved in the payment transaction is requesting payment or a promise of payment from the issuing financial institution 702 for the transaction. The authorization request may include a plurality of data elements, each data element being configured to store data as set forth in the associated standards, such as for storing an account number, application cryptogram, transaction amount, issuing financial institution 702 information, etc.

In step 734, the acquiring financial institution 710 may electronically transmit the authorization request to a transaction processing server 712 for processing. The transaction processing server 712 may be comprised of one or more computing devices as part of a payment network configured to process payment transactions. In some embodiments, the authorization request may be transmitted by a transaction processor at the acquiring financial institution 710 or other entity associated with the acquiring financial institution. The transaction processor may be one or more computing devices that include a plurality of communication channels for communication with the transaction processing server 712 for the transmission of transaction messages and other data to and from the transaction processing server 712. In some embodiments, the payment network associated with the transaction processing server 712 may own or operate each transaction processor such that the payment network may maintain control over the communication of transaction messages to and from the transaction processing server 712 for network and informational security.

In step 736, the transaction processing server 712 may perform value-added services for the payment transaction. Value-added services may be services specified by the issuing financial institution 702 that may provide additional value to the issuing financial institution 702 or the consumer 704 in the processing of payment transactions. Value-added services may include, for example, fraud scoring, transaction or account controls, account number mapping, offer redemption, loyalty processing, etc. For instance, when the transaction processing server 712 receives the transaction, a fraud score for the transaction may be calculated based on the data included therein and one or more fraud scoring algorithms and/or engines. In some instances, the transaction processing server 712 may first identify the issuing financial institution 702 associated with the transaction, and then identify any services indicated by the issuing financial institution 702 to be performed. The issuing financial institution 702 may be identified, for example, by data included in a specific data element included in the authorization request, such as an issuer identification number. In another example, the issuing financial institution 702 may be identified by the primary account number stored in the authorization request, such as by using a portion of the primary account number (e.g., a bank identification number) for identification.

In step 738, the transaction processing server 712 may electronically transmit the authorization request to the issuing financial institution 702. In some instances, the authorization request may be modified, or additional data included in or transmitted accompanying the authorization request as a result of the performance of value-added services by the transaction processing server 712. In some embodiments, the authorization request may be transmitted to a transaction processor (e.g., owned or operated by the transaction processing server 712) situated at the issuing financial institution 702 or an entity associated thereof, which may forward the authorization request to the issuing financial institution 702.

In step 740, the issuing financial institution 702 may authorize the transaction account for payment of the payment transaction. The authorization may be based on an available credit amount for the transaction account and the transaction amount for the payment transaction, fraud scores provided by the transaction processing server 712, and other considerations that will be apparent to persons having skill in the relevant art. The issuing financial institutin 702 may modify the authorization request to include a response code indicating approval (e.g., or denial if the transaction is to be denied) of the payment transaction. The issuing financial institution 702 may also modify a message type indicator for the transaction message to indicate that the transaction message is changed to be an authorization response. In step 742, the issuing financial institution 740 may transmit (e.g., via a transaction processor) the authorization response to the transaction processing server 712.

In step 744, the transaction processing server 712 may forward the authorization response to the acquiring financial institution 710 (e.g., via a transaction processor). In step 746, the acquiring financial institution may generate a response message indicating approval or denial of the payment transaction as indicated in the response code of the authorization response, and may transmit the response message to the gateway processor 708 using the standards and protocols set forth by the gateway processor 708. In step 748, the gateway processor 708 may forward the response message to the merchant 706 using the appropriate standards and protocols. In step 770, the merchant 706 may then provide the products purchased by the consumer 704 as part of the payment transaction to the consumer 704.

In some embodiments, once the process 700 has completed, payment from the issuing financial institution 702 to the acquiring financial institution 710 may be performed. In some instances, the payment may be made immediately or within one business day. In other instances, the payment may be made after a period of time, and in response to the submission of a clearing request from the acquiring financial institution 710 to the issuing financial institution 702 via the transaction processing server 702. In such instances, clearing requests for multiple payment transactions may be aggregated into a single clearing request, which may be used by the transaction processing server 712 to identify overall payments to be made by whom and to whom for settlement of payment transactions.

In some instances, the system may also be configured to perform the processing of payment transactions in instances where communication paths may be unavailable. For example, if the issuing financial institution is unavailable to perform authorization of the transaction account (e.g., in step 740), the transaction processing server 712 may be configured to perform authorization of transactions on behalf of the issuing financial institution. Such actions may be referred to as “stand-in processing,” where the transaction processing server “stands in” as the issuing financial institution 702. In such instances, the transaction processing server 712 may utilize rules set forth by the issuing financial institution 702 to determine approval or denial of the payment transaction, and may modify the transaction message accordingly prior to forwarding to the acquiring financial institution 710 in step 744. The transaction processing server 712 may retain data associated with transactions for which the transaction processing server 712 stands in, and may transmit the retained data to the issuing financial institution 702 once communication is reestablished. The issuing financial institution 702 may then process transaction accounts accordingly to accommodate for the time of lost communication.

In another example, if the transaction processing server 712 is unavailable for submission of the authorization request by the acquiring financial institution 710, then the transaction processor at the acquiring financial institution 710 may be configured to perform the processing of the transaction processing server 712 and the issuing financial institution 702. The transaction processor may include rules and data suitable for use in making a determination of approval or denial of the payment transaction based on the data included therein. For instance, the issuing financial institution 702 and/or transaction processing server 712 may set limits on transaction type, transaction amount, etc. that may be stored in the transaction processor and used to determine approval or denial of a payment transaction based thereon. In such instances, the acquiring financial institution 710 may receive an authorization response for the payment transaction even if the transaction processing server 712 is unavailable, ensuring that transactions are processed and no downtime is experienced even in instances where communication is unavailable. In such cases, the transaction processor may store transaction details for the payment transactions, which may be transmitted to the transaction processing server 712 (e.g., and from there to the associated issuing financial institutions 702) once communication is reestablished.

In some embodiments, transaction processors may be configured to include a plurality of different communication channels, which may utilize multiple communication cards and/or devices, to communicate with the transaction processing server 712 for the sending and receiving of transaction messages. For example, a transaction processor may be comprised of multiple computing devices, each having multiple communication ports that are connected to the transaction processing server 712. In such embodiments, the transaction processor may cycle through the communication channels when transmitting transaction messages to the transaction processing server 712, to alleviate network congestion and ensure faster, smoother communications. Furthermore, in instances where a communication channel may be interrupted or otherwise unavailable, alternative communication channels may thereby be available, to further increase the uptime of the network.

In some embodiments, transaction processors may be configured to communicate directly with other transaction processors. For example, a transaction processor at an acquiring financial institution 710 may identify that an authorization request involves an issuing financial institution 702 (e.g., via the bank identification number included in the transaction message) for which no value-added services are required. The transaction processor at the acquiring financial institution 710 may then transmit the authorization request directly to the transaction processor at the issuing financial institution 702 (e.g., without the authorization request passing through the transaction processing server 712), where the issuing financial institution 702 may process the transaction accordingly.

The methods discussed above for the processing of payment transactions that utilize multiple methods of communication using multiple communication channels, and includes fail safes to provide for the processing of payment transactions at multiple points in the process and at multiple locations in the system, as well as redundancies to ensure that communications arrive at their destination successfully even in instances of interruptions, may provide for a robust system that ensures that payment transactions are always processed successfully with minimal error and interruption. This advanced network and its infrastructure and topology may be commonly referred to as “payment rails,” where transaction data may be submitted to the payment rails from merchants at millions of different points of sale, to be routed through the infrastructure to the appropriate transaction processing servers 712 for processing. The payment rails may be such that a general purpose computing device may be unable to properly format or submit communications to the rails, without specialized programming and/or configuration. Through the specialized purposing of a computing device, the computing device may be configured to submit transaction data to the appropriate entity (e.g., a gateway processor 708, acquiring financial institution 710, etc.) for processing using this advanced network, and to quickly and efficiently receive a response regarding the ability for a consumer 704 to fund the payment transaction.

### Computer System Architecture

FIG. 8 illustrates a computer system 800 in which embodiments of the present disclosure, or portions thereof, may be implemented as computer-readable code. For example, the processing server 102 of FIG. 1 may be implemented in the computer system 800 using hardware, software, firmware, non-transitory computer readable media having instructions stored thereon, or a combination thereof and may be implemented in one or more computer systems or other processing systems. Hardware, software, or any combination thereof may embody modules and components used to implement, for example, the methods of FIGS. 4-7.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 818, a removable storage unit 822, and a hard disk installed in hard disk drive 812.

Various embodiments of the present disclosure are described in terms of this example computer system 800. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 804 may be a special purpose or a general purpose processor device. The processor device 804 may be connected to a communications infrastructure 806, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 800 may also include a main memory 808 (e.g., random access memory, read-only memory, etc.), and may also include a secondary memory 810. The secondary memory 810 may include the hard disk drive 812 and a removable storage drive 814, such as a floppy disk drive, a magnetic tape drive, an optical disk drive, a flash memory, etc.

The removable storage drive 814 may read from and/or write to the removable storage unit 818 in a well-known manner. The removable storage unit 818 may include a removable storage media that may be read by and written to by the removable storage drive 814. For example, if the removable storage drive 814 is a floppy disk drive or universal serial bus port, the removable storage unit 818 may be a floppy disk or portable flash drive, respectively. In one embodiment, the removable storage unit 818 may be non-transitory computer readable recording media.

In some embodiments, the secondary memory 810 may include alternative means for allowing computer programs or other instructions to be loaded into the computer system 800, for example, the removable storage unit 822 and an interface 820. Examples of such means may include a program cartridge and cartridge interface (e.g., as found in video game systems), a removable memory chip (e.g., EEPROM, PROM, etc.) and associated socket, and other removable storage units 822 and interfaces 820 as will be apparent to persons having skill in the relevant art.

Data stored in the computer system 800 (e.g., in the main memory 808 and/or the secondary memory 810) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 800 may also include a communications interface 824. The communications interface 824 may be configured to allow software and data to be transferred between the computer system 800 and external devices. Exemplary communications interfaces 824 may include a modem, a network interface (e.g., an Ethernet card), a communications port, a PCMCIA slot and card, etc. Software and data transferred via the communications interface 824 may be in the form of signals, which may be electronic, electromagnetic, optical, or other signals as will be apparent to persons having skill in the relevant art. The signals may travel via a communications path 826, which may be configured to carry the signals and may be implemented using wire, cable, fiber optics, a phone line, a cellular phone link, a radio frequency link, etc.

The computer system 800 may further include a display interface 802. The display interface 802 may be configured to allow data to be transferred between the computer system 800 and external display 830. Exemplary display interfaces 802 may include high-definition multimedia interface (HDMI), digital visual interface (DVI), video graphics array (VGA), etc. The display 830 may be any suitable type of display for displaying data transmitted via the display interface 802 of the computer system 800, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 808 and secondary memory 810, which may be memory semiconductors (e.g., DRAMs, etc.). These computer program products may be means for providing software to the computer system 800. Computer programs (e.g., computer control logic) may be stored in the main memory 808 and/or the secondary memory 810. Computer programs may also be received via the communications interface 824. Such computer programs, when executed, may enable computer system 800 to implement the present methods as discussed herein. In particular, the computer programs, when executed, may enable processor device 804 to implement the methods illustrated by FIGS. 4-7, as discussed herein. Accordingly, such computer programs may represent controllers of the computer system 800. Where the present disclosure is implemented using software, the software may be stored in a computer program product and loaded into the computer system 800 using the removable storage drive 814, interface 820, and hard disk drive 812, or communications interface 824.

The processor device 804 may comprise one or more modules or engines configured to perform the functions of the computer system 800. Each of the modules or engines may be implemented using hardware and, in some instances, may also utilize software, such as corresponding to program code and/or programs stored in the main memory 808 or secondary memory 810. In such instances, program code may be compiled by the processor device 804 (e.g., by a compiling module or engine) prior to execution by the hardware of the computer system 800. For example, the program code may be source code written in a programming language that is translated into a lower level language, such as assembly language or machine code, for execution by the processor device 804 and/or any additional hardware components of the computer system 800. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 800 to perform the functions disclosed herein. It will be apparent to persons having skill in the relevant art that such processes result in the computer system 800 being a specially configured computer system 800 uniquely programmed to perform the functions discussed above.

Techniques consistent with the present disclosure provide, among other features, systems and methods for analysis of metrics based on stored data sets. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for analysis of metrics based on stored data sets, comprising:
storing, in a transaction database of a specially programmed processing server, a plurality of transaction data entries, wherein each transaction data entry is a structured data set that includes data related to an electronic transaction including a plurality of data values storing data including at least an account identifier and a category code associated with a recipient of the electronic transaction and transaction data;
receiving, by a receiving device of the processing server, an electronic data signal superimposed with data comprising a metric request, wherein the metric request is related to a service provider and includes a plurality of data values storing data including at least one or more requested metrics and business data, the business data including data related to one or more customers of the related service provider;
identifying, by an identification module of the processing server, (i) a specific category code, or (ii) one or more account identifiers based on at least the business data included in the metric request;
executing, by a querying module of the processing server, a query on the transaction database to identify a subset of transaction data entries where (i) the included account identifier corresponds to one of the one or more account identifiers, or (ii) the included category code corresponds to the specific category code;
identifying, by a metric analysis module of the processing server, one or more metrics based on the transaction data included in each transaction data entry of the identified subset of transaction data entries, wherein each of the one or more metrics corresponds to one of the one or more requested metrics and is representative of business and/or industry performance; and
electronically transmitting, by a transmitting device of the processing server, a data signal superimposed with data comprising the identified one or more metrics in response to the metric request.

2. The method of claim 1, wherein
the business data includes the one or more account identifiers, and
identifying the one or more account identifiers includes identifying, in the business data included in the metric request, the one or more account identifiers.

3. The method of claim 1, wherein
the business data includes the specific category code, and
identifying the specific category code includes identifying, in the business data included in the metric request, the specific category code.

4. The method of claim 1, wherein
the business data includes a specific account identifier associated with the related service provider, and
identifying the one or more account identifiers includes:
executing, by the querying module of the processing server, a query on the transaction database to identify a group of transaction data entries where the account
identifier associated with the recipient corresponds to the specific account identifier; and
identifying, by the identification module of the processing server, the one or more account identifiers by identifying, in each of the identified group of transaction data entries, an account identifier associated with a giver of the related electronic transaction.

5. The method of claim 1, wherein
the business data includes a specific account identifier associated with the related service provider, and
identifying the specific category code includes:
executing, by the querying module of the processing server, a query on the transaction database to identify a group of transaction data entries where the account identifier associated with the recipient corresponds to the specific account identifier; and
identifying, by the identification module of the processing server, the specific category code as corresponding to the category code associated with a payer included in a majority of the group of transaction data entries.

6. The method of claim 1, wherein each transaction data entry stored in the transaction database includes a transaction date.

7. The method of claim 6, wherein
the transaction date included in each transaction data entry in the identified subset is within a period of time, and
the metric request further includes the period of time.

8. The method of claim 6, wherein
the one or more metrics are further based on the transaction date included in each transaction data entry of the identified subset, and
the one or more metrics includes a prediction of future performance.

9. The method of claim 1, further comprising:
storing, in an account database of the processing server, a plurality of account data entries, wherein each account data entry is a structured data set that includes data related to an account including a plurality of data values storing data including at least an account identifier and (i) a related category code, or (ii) one or more related account identifiers, wherein
the business data further includes a specific account identifier, and
(i) the specific category code corresponds to the related category code, or (ii) the one or more account identifiers corresponds to the one or more related account identifiers included in a specific account profile of the plurality of account profiles where the included account identifier corresponds to the specific account identifier.

10. The method of claim 1, further comprising:
storing, in an account database of the processing server, a plurality of account data entries, wherein each account data entry is a structured data set that includes data related to an account including a plurality of data values storing data including at least a category code and a related category code, wherein
the business data further includes a requested category code, and
the specific category code corresponds to the related category code included in a specific account profile of the plurality of account profiles where the included category code corresponds to the requested category code.

11. A system for analysis of metrics based on stored data sets, comprising:
a transaction database of a specially programmed processing server configured to store a plurality of transaction data entries, wherein each transaction data entry is a structured data set that includes data related to an electronic transaction including a plurality of data values storing data including at least an account identifier and a category code associated with a recipient of the electronic transaction and transaction data;
a receiving device of the processing server configured to receive an electronic data signal superimposed with data comprising a metric request, wherein the metric request is related to a service provider and includes a plurality of data values storing data including at least one or more requested metrics and business data, the business data including data related to one or more customers of the related service provider;
an identification module of the processing server configured to identify (i) a specific category code, or (ii) one or more account identifiers based on at least the business data included in the metric request;
a querying module of the processing server configured to execute a query on the transaction database to identify a subset of transaction data entries where (i) the included account identifier corresponds to one of the one or more account identifiers, or (ii) the included category code corresponds to the specific category code;
a metric analysis module of the processing server configured to identify one or more metrics based on the transaction data included in each transaction data entry of the identified subset of transaction data entries, wherein each of the one or more metrics corresponds to one of the one or more requested metrics and is representative of business and/or industry performance; and
a transmitting device of the processing server configured to electronically transmit a data signal superimposed with data comprising the identified one or more metrics in response to the metric request.

12. The system of claim 11, wherein
the business data includes the one or more account identifiers, and
identifying the one or more account identifiers includes identifying, in the business data included in the metric request, the one or more account identifiers.

13. The system of claim 11, wherein
the business data includes the specific category code, and
identifying the specific category code includes identifying, in the business data included in the metric request, the specific category code.

14. The system of claim 11, wherein
the business data includes a specific account identifier associated with the related service provider, and
identifying the one or more account identifiers includes:
executing, by the querying module of the processing server, a query on the transaction database to identify a group of transaction data entries where the account identifier associated with the recipient corresponds to the specific account identifier; and
identifying, by the identification module of the processing server, the one or more account identifiers by identifying, in each of the identified group of transaction data entries, an account identifier associated with a giver of the related electronic transaction.

15. The system of claim 11, wherein
the business data includes a specific account identifier associated with the related service provider, and
identifying the specific category code includes:
executing, by the querying module of the processing server, a query on the transaction database to identify a group of transaction data entries where the account identifier associated with the recipient corresponds to the specific account identifier; and
identifying, by the identification module of the processing server, the specific category code as corresponding to the category code associated with a payer included in a majority of the group of transaction data entries.

16. The system of claim 11, wherein each transaction data entry stored in the transaction database includes a transaction date.

17. The system of claim 16, wherein
the transaction date included in each transaction data entry in the identified subset is within a period of time, and
the metric request further includes the period of time.

18. The system of claim 16, wherein
the one or more metrics are further based on the transaction date included in each transaction data entry of the identified subset, and
the one or more metrics includes a prediction of future performance.

19. The system of claim 11, further comprising:
an account database of the processing server configured to store a plurality of account data entries, wherein each account data entry is a structured data set that includes data related to an account including a plurality of data values storing data including at least an account identifier and (i) a related category code, or (ii) one or more related account identifiers, wherein
the business data further includes a specific account identifier, and
(i) the specific category code corresponds to the related category code, or (ii) the one or more account identifiers corresponds to the one or more related account identifiers included in a specific account profile of the plurality of account profiles where the included account identifier corresponds to the specific account identifier.

20. The system of claim 11, further comprising:
an account database of the processing server configured to store a plurality of account data entries, wherein each account data entry is a structured data set that includes data related to an account including a plurality of data values storing data including at least a category code and a related category code, wherein
the business data further includes a requested category code, and
the specific category code corresponds to the related category code included in a specific account profile of the plurality of account profiles where the included category code corresponds to the requested category code.
